(19) United States
(12) Patent Application Publication
(10) Pub. No.: US 2023/0062373 A1
(43) Pub. Date: Mar. 2, 2023

(54) DISPLAY DEVICE AND DISPLAY SYSTEM

(71) Applicant: KABUSHIKI KAISHA TOKAI RIKA DENKI SEISAKUSHO, Aichi (JP)

(72) Inventor: Yasuhiro ONO, Aichi (JP)

(21) Appl. No.: 17/759,922

(22) PCT Filed: Feb. 1, 2021
(86) PCT No.: PCT/JP2021/003559

§ 371 Date: Aug. 1, 2022

(30) Foreign Application Priority Data
Feb. 5, 2020 (JP) 2020-017806

(51) Int. Cl. H04N 9/31; G09G 3/00; G02F 1/01

(52) U.S. Cl. CPC H04N 9/3155; G09G 3/003; H04N 9/3194; G02F 1/0121; G09G 2320/0626; G09G 2380/10; G09G 2360/144

(57) ABSTRACT

A display device is provided with an input unit for inputting a detection signal from a detection unit capable of detecting the brightness of ambient light around a dimming member. The display device is also provided with a control unit which, on the basis of the detection signal input by the input unit, controls at least one of the optical transmittance of the dimming member and the operation of a projector to adjust an image projected onto the dimming member to a display state corresponding to the brightness of the ambient light.

### TECHNICAL FIELD

The present invention relates to a display device and a display system.

### BACKGROUND ART

A known display system shows an image by projecting the image with a projector onto a light control member having a variable light transmittance. Patent Document 1 describes a display system that controls the light transmittance of the light control member. The light control member is controlled to become opaque when showing projected images and transparent when not showing projected images.

### CITATION LIST

### Patent Literature

Patent Literature 1: Japanese Laid-Open Patent Publication No. 2017-90617

### SUMMARY OF INVENTION

The projected image gives a user different impressions depending on the brightness of the environment surrounding the light control member. Accordingly, there may be a need to display an image that is easily recognizable in accordance with the brightness of the surrounding environment.

An objective of the present invention is to provide a display device and a display system that improve visual recognition.

A display device that solves the above problem shows an image by projecting the image from a projector onto a light control member having a variable light transmittance and arranged on an optical material. The display device includes an input unit and a controller. The input unit receives a detection signal from a detector configured to detect a brightness of ambient light around the light control member. The controller controls at least one of the light transmittance of the light control member and operation of the projector based on the detection signal received by the input unit to adjust a display state of the image projected onto the light control member in accordance with the brightness of the ambient light.

A display system that solves the above problem shows an image on a light control member and includes the light control member and a projector. The light control member has a variable light transmittance and is arranged on an optical material. The projector projects the image onto the light control member. The display system also includes a detector and a display device. The detector is configured to detect a brightness of ambient light around the light control member. The display device receives a detection signal from the detector and controls at least one of the light transmittance of the light control member and operation of the projector based on the received detection signal to adjust a display state of the image projected onto the light control member in accordance with the brightness of the ambient light.

### Advantageous Effects of Invention

The display device and the display system according to the present invention improve visual recognition.

### BRIEF DESCRIPTION OF DRAWINGS

FIG. 1 is a block diagram showing the configuration of a display system.

FIG. 2 is a schematic diagram illustrating the projection of an image onto a display screen.

FIG. 3 is a table showing a control map.

FIG. 4 is a table showing a conversion map.

FIG. 5 is a flowchart illustrating the procedure for adjusting image display.

FIG. 6 is a flowchart illustrating the procedure for readjusting the image display.

### DESCRIPTION OF EMBODIMENT

An embodiment of a display device and a display system will now be described with reference to the drawings.

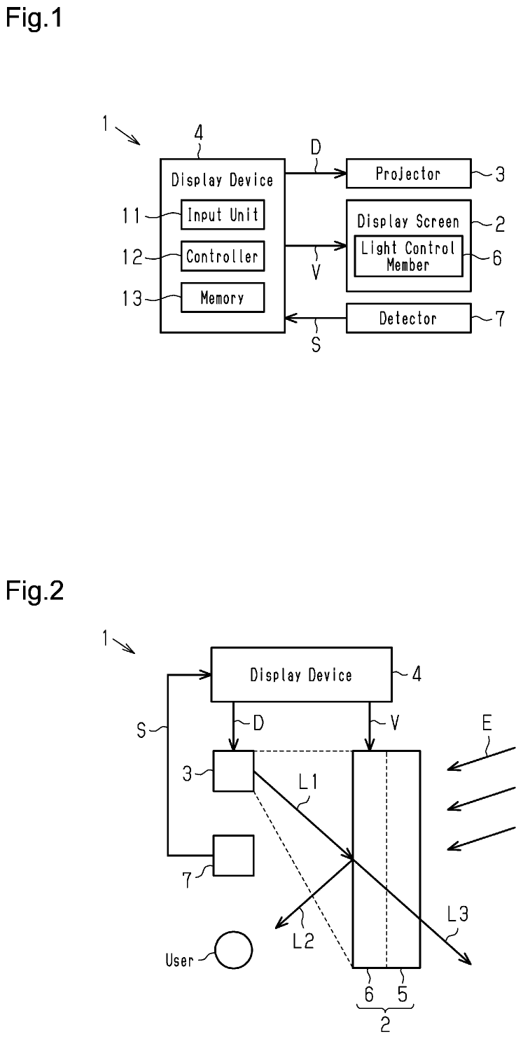

As shown in FIG. 1, a display system 1 includes a display screen 2, a projector 3, and a display device 4. The projector 3 projects an image onto the display screen 2. The display device 4 controls the shown image. The projector 3 is, for example, a laser projector. The display device 4 outputs image data D of the image that will be projected to the projector 3. The projector 3 projects the image that corresponds to the received image data D onto the display screen 2. In the present embodiment, the display screen 2 is arranged in a vehicle and shows the image to a user in the vehicle. The image includes a picture, a still image, a video, character information, and/or the like indicating various types of information.

As shown in FIG. 2, the display screen 2 includes an optical material 5 and a light control member 6. The optical material 5 is formed by a transparent member such as a light-transmissive glass. The light control member 6 has a variable light transmittance. The light control member 6 is bonded to the optical material 5. In the present embodiment, the optical material 5 is a glass material of a vehicle such as a window glass of side door for a rear seat. The light control member 6 is a liquid crystal material of which the light transmittance decreases in accordance with, for example, the voltage applied. For example, as the light transmittance decreases and the light control member 6 becomes opaque, the shown image projected from the projector 3 becomes clearer. The display device 4 outputs a control voltage V to the light control member 6 to control the light transmittance.

The projector 3 is arranged on a ceiling or the like inside the passenger compartment to project an image onto the display screen 2 from inside the passenger compartment. That is, the projector 3 is of a front projection type in which the projector 3 and the user are at the same side of the display screen 2. The projector 3 emits image light L1 toward the display screen 2 based on the image data D. The image light L1 is divided into reflected light L2 and transmitted light L3 in accordance with the light transmittance of the light control member 6 of the display screen 2. The reflected light L2 is diffusely reflected on the light control member 6. The transmitted light L3 is transmitted through the display screen 2. When the user views the display screen 2, the user visually perceives the reflected light L2 and recognizes the image shown on the display screen 2. Further, the projector 3 intermittently displays the image on the light control member 6. During the intermittent display, the time during which no image is shown, that is, the time during which the projector 3 does not emit the image light L1, is controlled in fixed or non-fixed time intervals.

In addition to the image light L1, ambient light E is emitted to and around the light control member 6 by light sources located inside and outside the vehicle. Examples of the ambient light E include sunlight from outside the vehicle and external light produced by lighting outside the vehicle. The ambient light E from outside the vehicle enters the passenger compartment through the display screen 2. Further, the brightness A of the ambient light E affects the brightness of the image visually perceived by the user. For example, if the brightness A of the ambient light E is brighter than the reflected light L2, the projected image will appear to be dark, and if the brightness A of the ambient light E is darker than the reflected light L2, the projected image will appear to be bright. Accordingly, the display system 1 of the present embodiment has a functionality to control a display state of the image in accordance with the brightness A of the ambient light E.

The display system 1 includes a detector 7 configured to detect the brightness A of the ambient light E around the light control member 6. The detector 7 is, for example, an illuminometer that detects the intensity of illumination inside the passenger compartment as the brightness A around the light control member 6. The illuminometer is arranged to detect, for example, the intensity of the light emitted to the display screen 2 or the intensity of the light emitted to the user. The detector 7 outputs a detection signal S to the display device 4 as a detection result.

As shown in FIG. 1, the display device 4 includes an input unit 11 and a controller 12. The input unit 11 receives the detection signal S from the detector 7. The controller 12 adjusts the display state of the image based on the detection signal S received by the input unit 11. The controller 12 controls at least one of the light transmittance of the light control member 6 and operation of the projector 3 based on the detection signal S so that the display state is controlled in accordance with the brightness A of the ambient light E. In the present embodiment, the controller 12 controls the light transmittance of the light control member 6 with the control voltage V and controls the operation of the projector 3 with the image data D.

The display device 4 includes a memory 13 that allows for the writing and reading of various types of data. The memory 13 stores in advance a control map used for adjusting the display state of the image.

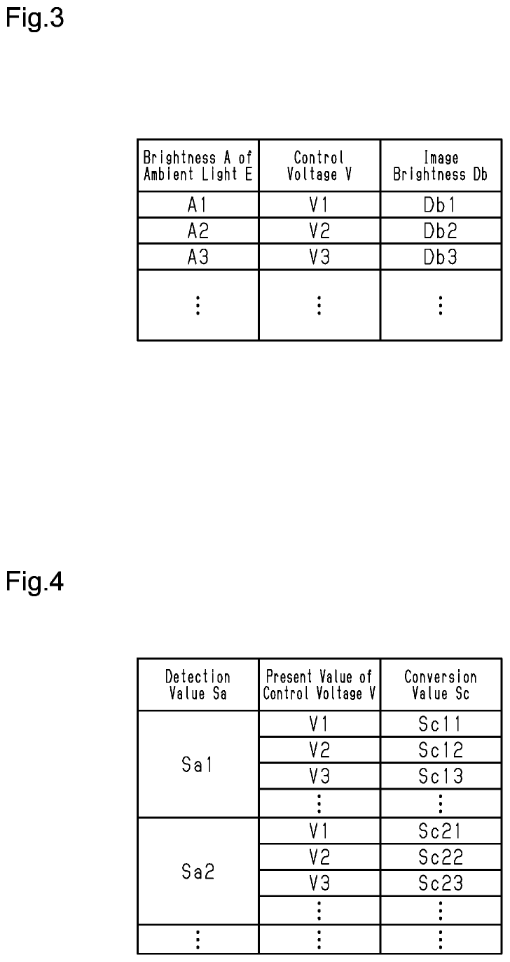

As shown in FIG. 3, the control map indicates the relationship of the brightness A of the ambient light E, a voltage value of the control voltage V output to the light control member 6, and an image brightness Db of the image projected from the projector 3. The voltage value of the control voltage V corresponds to “the first instruction value” for controlling the light control member 6. Further, the image brightness Db corresponds to “the second instruction value” for controlling the projector 3. The image brightness Db is, for example, the brightness value of the pixels in the image data D input to the projector 3. The brightness value may be a statistical value such as a maximum value, a minimum value, an average value, or the like of the pixels.

When the controller 12 acquires the brightness A of the ambient light E from a detection signal S, the controller 12 uses the control map to obtain the control voltage V and the image brightness Db corresponding to the brightness A of the ambient light E. Then, the controller 12 adjusts the display state of the image with the obtained control voltage V and the obtained image brightness Db.

The controller 12 readjusts the display state of the image based on a detection signal S obtained at a time during which the image is not shown during the intermittent display performed by the projector 3. The controller 12 may control the time during which no image is shown in fixed time intervals by, for example, inserting black image data D between sets of the image data D. The controller 12 may control the time during which no image is shown in non-fixed time intervals by, for example, switching the screen. Further, the controller 12 repeats the readjustment at specified times. For example, the controller 12 performs the readjustment whenever no image is shown during the intermittent display. The memory 13 of the display device 4 stores in advance a conversion map used for the readjustment.

As shown in FIG. 4, the conversion map indicates the relationship of a detection value Sa of the detection signal S, the present value that has been set as the control voltage V when the detection occurred, and a conversion value Sc of the detection signal S. When the controller 12 receives a detection signal S while controlling the light control member 6 with the control voltage V, the controller 12 uses the conversion map to convert the detection value Sa into the conversion value Sc so that the conversion value Sc corresponds to the brightness A of the ambient light E. Then, the controller 12 obtains from the control map a new control voltage V and a new image brightness Db corresponding to the brightness A of the ambient light E, which was acquired from the conversion value Sc, to readjust the display state of the image in accordance with the new control voltage V and the new image brightness Db.

The operation of the present embodiment will now be described. It is assumed here that the control voltage V and the image data D are not being output by the display device 4, that is, the display device 4 is in an uncontrolled state. Further, it is assumed that in the uncontrolled state, image light L1 is not emitted from the projector 3.

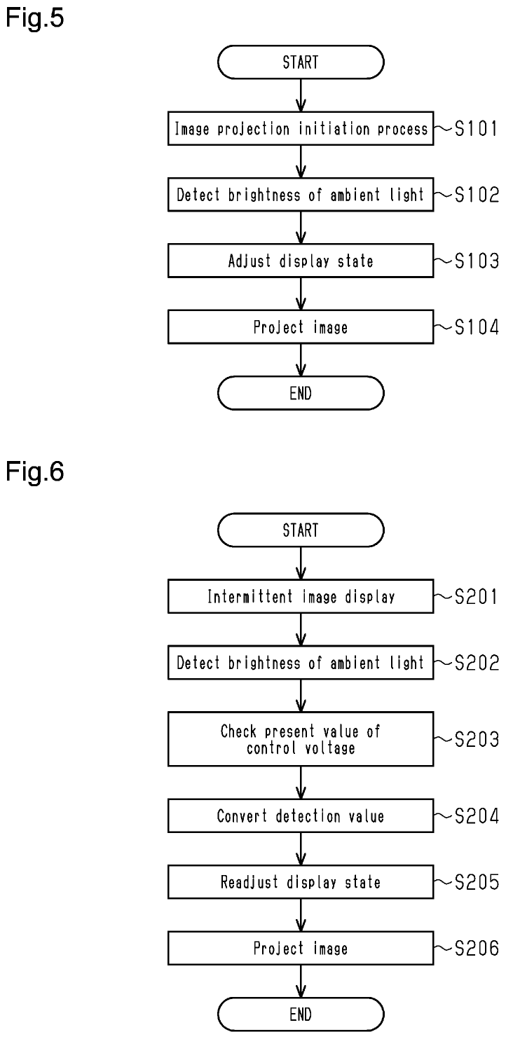

As shown in FIG. 5, in S101 (“S” stands for step), the display device 4 performs an image projection initiation process. The image projection initiation process is performed when, for example, the user carries out an operation. In the image projection initiation process, for example, the display device 4 acquires the image data D that is to be projected or reads the image data D stored in advance in the memory 13.

In S102, the detector 7 detects the brightness A of the ambient light E around the light control member 6. The detector 7 of the present embodiment detects the intensity of illumination inside the passenger compartment and outputs a detection signal S including the detection value Sa to the display device 4.

In S103, the controller 12 of the display device 4 adjusts the display state of the image based on the detection signal S received by the input unit 11. In the present embodiment, when the detection signal S is received, the controller 12 uses the control map to obtain the control voltage V and the image brightness Db and adjusts the display state of the image with the control voltage V and the image brightness Db.

The concept of the display state of an image will now be described.

The light transmittance of the light control member 6 affects the display state of an image. If the brightness of the ambient light E and the brightness of the image light L1 were to be constant, an increase in the light transmittance of the light control member 6 would decrease the reflected light L2 and increase the transmitted light L. Thus, the image would be shown on the display screen 2 in a dark display state. Further, a decrease in the light transmittance of the light control member 6 would increase the reflected light L2 and decrease the transmitted light L3. Thus, the image would be shown on the display screen 2 in a bright display state.

Therefore, in the control map, the control voltage V is associated with the brightness A of the ambient light E such that the light transmittance of the light control member 6 decreases as the brightness A of the ambient light E increases. Accordingly, the controller 12 controls the light control member 6 such that the light transmittance of the light control member 6 increases as the brightness A of the ambient light E decreases. Further, the controller 12 controls the light control member 6 such that the light transmittance of the light control member 6 decreases as the brightness A of the ambient light E increases.

The image brightness Db also affects the display state of an image. If the brightness A of the ambient light E and the light transmittance of the light control member 6 were to be constant, an increase in the image brightness Db would show the image in a bright display state. Further, a decrease in the image brightness Db would show the image in a dark display state.

Therefore, in the control map, the image brightness Db is associated with the brightness A of the ambient light E such that the image brightness Db increases as the brightness A of the ambient light E increases. Accordingly, the controller 12 controls the projector 3 such that the image brightness Db of the image projected from the projector 3 decreases as the brightness A of the ambient light E decreases. Further, the controller 12 controls the projector 3 such that the image brightness Db increases as the brightness A of the ambient light E increases.

As shown in FIG. 3, as described above, the control map indicates the relationship of the brightness A of the ambient light E, the control voltage V, and the image brightness Db. When the controller 12 receives a detection signal S in an uncontrolled state, the controller 12 acquires the detection value Sa included in the detection signal S as the brightness A of the ambient light E. The controller 12 uses the control map to obtain the control voltage V and the image brightness Db corresponding to the brightness A of the ambient light E. For example, when the brightness A of the ambient light E is “A1”, the controller 12 obtains “V1” and “Db1” as the control voltage V and the image brightness Db, respectively. The controller 12 outputs the control voltage V to the light control member 6 so that the control voltage V becomes “V1” to control the light transmittance. In other words, the controller 12 supplies the light control member 6 with the control voltage V having the voltage value “V1”. Also, the controller 12 processes the image data D so that the image brightness Db becomes “Db1” and outputs the processed image data D to the projector 3.

Returning to FIG. 5, in S104, the projector 3 projects the processed image data D onto the light control member 6 of the display screen 2 to show the image. The brightness of the projected image corresponds to the light transmittance of the light control member 6, which is controlled with the control voltage V, and the image brightness Db of the image data D. In this manner, the display state of the image is adjusted with the control voltage V and the image brightness Db, which are associated with the brightness A of the ambient light E, using the control map. Thus, the display state of the image is controlled in accordance with the brightness A of the ambient light E.

As shown in FIG. 2, the ambient light E includes, for example, light from outside the passenger compartment. The brightness of the outside light changes depending on where and when the vehicle travels. Accordingly, the brightness A of the ambient light E also changes during use of the display device 4. The display device 4 of the present embodiment readjusts the display state in accordance with such changes in the brightness A of the ambient light E.

As shown in FIG. 6, in S201, during a period in which an image is shown, the projector 3 intermittently displays the image. The intermittent display shows no image at certain times. The projector 3 performs the intermittent display by, for example, having the controller 12 insert a black image between sets of image data D in fixed time intervals. Preferably, the display time during intermittent display is extremely short and cannot be recognized by the user.

In S202, the detector 7 detects the brightness A of the ambient light E at a time during which the image is not shown and outputs the detection value Sa on a detection signal S to the display device 4. For example, the controller 12 controls the detector 7 to detect the brightness A of the ambient light E at a time during which the image is not shown. In this manner, the controller 12 receives the detection signal S obtained at a time during which the image is not shown.

In S203, the controller 12 checks the present value of the control voltage V that has been set when the detection of the detection signal S occurred. For example, the controller 12 re-reads the voltage value of the control voltage V that was obtained from the control map in the preceding cycle and acknowledges this voltage value as the present value.

In S204, the controller 12 uses the conversion map to perform conversion on the detection value Sa. The controller 12 uses the conversion map to obtain the conversion value Sc corresponding to the detection value Sa, which is included in the detection signal S, and the present value of the control voltage V. The controller 12 acquires the conversion value Sc as the brightness A of the ambient light E.

The concept of the conversion value Sc will now be described.

When detecting the brightness A of the ambient light E, the light transmittance of the light control member 6 affects the detection value Sa of the brightness A of the ambient light E. For example, if the light transmittance of the light control member 6 is increased when the image light L1 is not being emitted, the ambient light E entering the passenger compartment through the display screen 2 will increase and the brightness A of the ambient light E will increase. Further, if the light transmittance of the light control member 6 is decreased, the ambient light E entering the passenger compartment through the display screen 2 will decrease and the brightness A of the ambient light E will decrease.

As shown in FIG. 4, the conversion map indicates the relationship of the detection value Sa, the present value of the control voltage V, and the conversion value Sc. In the present embodiment, in the conversion map, the detection value Sa is associated with the conversion value Sc such that the conversion value Sc corresponds to a brighter state when the detection value Sa corresponds to a brighter state. Further, when the detection value Sa is the same, the present value of the control voltage V is associated with the conversion value Sc such that the conversion value Sc corresponds to a brighter state as the present value of the control voltage V changes in a direction in which the light transmittance decreases.

The controller 12 uses the conversion map to obtain the conversion value Sc from the detection value Sa and the present value of the control voltage V. For example, when the detection value Sa is “Sa1” and the present value of the control voltage V is “V1”, the controller 12 obtains “Sc11” as the conversion value Sc. Further, for example, when the detection value Sa is “Sa1” and the present value of the control voltage V is “V2”, the controller 12 obtains “Sc12” as the conversion value Sc. The controller 12 acquires the conversion value Sc as the brightness A of the ambient light E in the control map.

Returning of FIG. 6, in S205, the controller 12 obtains a new control voltage V and a new image brightness Db corresponding to the brightness A of the ambient light E, which was acquired from the conversion value Sc, and readjusts the display state of the image in accordance with the new control voltage V and the new image brightness Db.

In S206, the projector 3 projects the image light corresponding to the image data D, which was processed by the readjustment, onto the light control member 6 of the display screen 2. The brightness of the projected image corresponds to the light transmittance of the light control member 6 controlled by the control voltage V and the image brightness Db of the image data D.

The controller 12 repeats the readjustment process of S201 to S206 at specified times. For example, the controller 12 performs the readjustment each time no image is shown during the intermittent display. In this manner, the readjustment is performed according to changes in the brightness A of the ambient light E during image display. This controls the display state of the image in accordance with the brightness A of the ambient light E.

As described above, the controller 12 uses the control map to adjust the display state of the image projected onto the light control member 6 in accordance with the brightness A of the ambient light E. This adjusts the brightness of the image perceived by the user in accordance with the brightness A of the ambient light E around the light control member 6. Further, the display state is readjusted when the brightness A of the ambient light E changes.

When showing an image, the controller 12 uses a detection signal S obtained at a time at which no image is shown during the intermittent display to readjust the image. Thus, the image light L1 emitted from the projector 3 does not affect the detection result of the detector 7 and allows the brightness A of the ambient light E to be detected correctly.

The controller 12 uses the control map to control both the light transmittance of the light control member 6 and the operation of the projector 3. This allows the brightness of an image to be controlled over a wider range than when controlling only one of the light transmittance of the light control member 6 and the operation of the projector 3.

The controller 12 uses the conversion map to obtain the conversion value Sc of the detection signal S from the detection value of the detection signal S and the present value of the control voltage V. Then, the controller 12 uses the conversion value Sc as the brightness A of the ambient light E to obtain a new control voltage V and a new image brightness Db from the control map and readjusts the display state of the image with the new control voltage V and the new image brightness Db. In this manner, when controlling the light control member 6, the controller 12 converts the detection value Sa of the detector 7, which changes with the light transmittance of the light control member 6, with the conversion map and performs the readjustment in accordance with the obtained conversion value Sc with the control map. This readjusts the display state of the image in a preferred manner.

The controller 12 processes the image data D of the image projected onto the light control member 6 to control the operation of the projector 3. Thus, the projector 3 only needs to project the received image data D. This simplifies the process performed by the projector 3.

The present embodiment has the following advantages.

(1) The display device 4 includes the input unit 11 that receives a detection signal S from the detector 7 configured to detect the brightness A of the ambient light E around the light control member 6. Further, the display device 4 includes the controller 12 that controls at least one of the light transmittance of the light control member 6 and the operation of the projector 3 based on the detection signal S received by the input unit 11 to adjust the display state of an image projected onto the light control member 6 in accordance with the brightness A of the ambient light E. This configuration adjusts the brightness of the image perceived by a user in accordance with the brightness A of the ambient light E around the light control member 6. Thus, visual recognition is improved.

(2) The projector 3 intermittently displays an image onto the light control member 6. Further, the controller 12 performs readjustment of the display state based on a detection signal S obtained at a time during which no image is shown and repeats the readjustment at specified times. This configuration performs the readjustment in accordance with changes in the brightness A of the ambient light E when the display device 4 is in use. Thus, the display state of the image is controlled in accordance with changes in the brightness A of the ambient light E. Furthermore, the image is readjusted based on the detection signal S obtained at a time during which no image is shown so that the image light L1 projected from the projector 3 does not affect the detection result of the detector 7. This correctly detects the brightness A of the ambient light E and properly readjusts the display state of the image. Thus, visual recognition is improved.

(3) When controlling the light control member 6 with the control voltage V, the controller 12 uses the conversion map to obtain the conversion value Sc from the detection value Sa and the present value of the control voltage V. Further, when using the obtained conversion value Sc as the brightness A of the ambient light E, the controller 12 obtains a new control voltage V and a new image brightness Db corresponding to the brightness A of the ambient light E from the control map and readjusts the display state with the new control voltage V and the new image brightness Db. With this configuration, when controlling the light control member 6, the controller 12 converts the detection value Sa of the detector 7, which changes with the light transmittance of the light control member 6, with the conversion map and performs readjustment in accordance with the obtained conversion value Sc with the control map. This readjusts the display state of the image in a preferred manner and improves visual recognition.

(4) The controller 12 executes control such that the light transmittance of the light control member 6 increases as the brightness A of the ambient light E decreases and the light transmittance of the light control member 6 decreases as the brightness A of the ambient light E increases. With this configuration, when the brightness A of the ambient light E decreases, the light transmittance is increased to show the image in a dark display state so that the image will not be too bright and difficult to view. Further, when the brightness A of the ambient light E increases, the light transmittance is decreased to show the image in a bright display state so that the image will not be too dark and difficult to view. This improves visual recognition.

(5) The controller 12 executes control such that the image brightness Db of the image projected from the projector 3 decreases as the brightness A of the ambient light E decreases and the image brightness Db of the image projected from the projector 3 increases as the brightness A of the ambient light E increases. With this configuration, when the brightness A of the ambient light E decreases, the image brightness Db is decreased to show the image in a dark display state so that the image will not be too bright and difficult to view. Further, when the brightness A of the ambient light E increases, the image brightness Db is increased to show the image in a bright display state so that the image will not be too dark and difficult to view. This improves visual recognition.

(6) The controller 12 processes the image data D of the image projected onto the light control member 6 to control the operation of the projector 3. With this configuration, the projector 3 only needs to project the received image data D. This simplifies the process performed by the projector 3 and the configuration of the projector 3.

(7) The light control member 6 is arranged on a glass of a vehicle. This configuration improves visual recognition of the image shown on the glass of the vehicle.

The present embodiment may be modified as follows. The present embodiment and the following modifications can be combined as long as the combined modifications remain technically consistent with each other.

The controller 12 does not have to process the image data D to control the operation of the projector 3. The controller 12 may control the irradiation intensity of the light source of the projector 3.

The controller 12 may show an image in a dark display state when the brightness A of the ambient light E increases and show an image in a bright display state when the brightness A of the ambient light E decreases.

The image brightness Db may be any value related to the brightness of the projected image. For example, the image brightness Db may be a brightness value of the pixels in the image data D, the irradiation intensity of the light source of the projector 3, or the intensity of the brightness filter.

The first instruction value for controlling the light transmittance of the light control member 6 is not limited to that in the description of the present embodiment.

The second instruction value for controlling the operation of the projector 3 is not limited to that in the description of the present embodiment.

The controller 12 may check the present value of the control voltage V by detecting the output voltage value of the control voltage V.

In an uncontrolled state, the controller 12 may check the present value of the control voltage V and obtain the conversion value Sc. In other words, the controller 12 may check the present value of the control voltage V and obtain the conversion value Sc each time the controller 12 controls the display state of an image.

The control map may include a range in which the control is executed with only one of the control voltage V and the image brightness Db in accordance with the brightness A of the ambient light E and the other one of the control voltage V and the image brightness Db is not changed. In other words, when the brightness A of the ambient light E is in a certain range, the control map can associate brightness A of the ambient light E with the control voltage V and the image brightness Db, with one of the control voltage V and the image brightness Db having various values and the other one of the control voltage and the image brightness Db not having various values.

In the conversion map, the relationship of the control voltage V and the conversion value Sc is not limited to that in the description of the present embodiment. For example, the control voltage V and the conversion value Sc may be associated so that the conversion value Sc corresponds to a darker state as the control voltage V changes in a direction in which the light transmittance decreases.

In the conversion map, the detection value Sa prior to the conversion may be the same as the conversion value Sc subsequent to the conversion.

In the control map, the relationship of the brightness A of the ambient light E, the control voltage V, and the image brightness Db is not limited and may be changed as required.

In the conversion map, the relationship of the detection value Sa, the present value of the control voltage V, and the conversion value Sc is not limited and may be changed as required.

The controller 12 does not have to use the control map and the conversion map to execute control and may, for example, increment or decrement the control voltage V or the image brightness Db in accordance with the brightness of the ambient light E.

When the light control member 6 is being controlled with the control voltage V, the controller 12 may check the time when a detection signal S is obtained to determine a detection signal S that is obtained at a time during which no image is shown. In other words, as long as the brightness A of the ambient light E is detected at a time during which an image is not shown, there is no limit to the detection method.

When an image is being projected, the controller 12 does not have to execute control based on the detection signal S obtained at a time during which no image is shown. The controller 12 may execute control based on the detection signal S obtained when the image light is being emitted.

The controller 12 may control only one of the light transmittance of the light control member 6 and the operation of the projector. In other words, the controller 12 only needs to control at least one of the light transmittance of the light control member 6 and the operation of the projector.

The ambient light E is not limited to the light entering the inside of the vehicle from outside the vehicle through the display screen 2 and may include the light from a light source located inside the passenger compartment and/or the outside light entering the inside of the vehicle through a glass other than the display screen 2.

The detector 7 does not have to detect the brightness of the ambient light inside passenger compartment as the brightness around the light control member 6. The detector 7 may detect the brightness of the ambient light around the light control member 6 at the outer side of the passenger compartment as the brightness around the light control member 6.

The detector 7 does not have to detect the intensity of illumination inside the passenger compartment as described in the embodiment above. For example, the detector 7 may detect the brightness of the light emitted toward the user from the side of the display screen 2.

The detector 7 may be applied to any of various types of devices configured to detect brightness, such as an illuminometer arranged inside the passenger compartment or a camera directed toward the user.

The optical material 5 of the display screen 2 is not limited to a transparent member and may be, for example, a mirror. For example, the display screen 2 may be a sideview mirror, a rearview mirror, or the like.

The display system 1 may include an operation unit configured to change the brightness of the projected image in accordance with a user operation. Further, the operation unit may be a physical switch, a touch-operation unit that is touched and operated, a camera that detects a gesture, or the like.

The light control member 6 may be transparent when no voltage is applied and have a light transmittance that is decreased in accordance with the applied voltage. Alternatively, the light control member 6 may be opaque when no voltage is applied and have a light transmittance that is increased in accordance with the applied voltage.

The light control member 6 may be a liquid crystal material, an electrochromic material, a photochromic material, or the like.

The projector 3 may be of a front projection type in which the projector 3, which projects an image, and the user are at the same side of the display screen 2 or a rear projection type in which the projector 3, which projects an image, and the user are at opposite sides of the display screen 2.

The projector 3 is not limited to a laser projector and may be applied to any of various types of projectors.

The installation position of the projector 3 is not limited, and the projector 3 may be arranged, for example, inside or outside the passenger compartment of a vehicle. The projector 3 may be arranged on a ceiling inside the passenger compartment or a sideview mirror outside the passenger compartment.

Image projection may be initiated by any event such as a user operation, power source transition of the vehicle, or communication with another device.

There is no limit to the content of the projected image. For example, the contents projected by an image may indicate various types of information or pictures in cooperation with an on-board device such as a navigation system and an audio device. Further, the contents projected by an image may indicate road information and/or information and advertisement of nearby facilities.

The projected image may include a picture, a still image, a video, character information, and the like.

The display system 1 does not have to be applied to a vehicle and may be arranged on various types of equipment and apparatus or in a building or facility.

The display device 4 can be circuitry including one or more processors that run on a computer program (software) to execute various processes, one or more exclusive hardware circuits such as an application specific integrated circuit (ASIC) that execute at least part of various processes, or a combination of the above. A processor includes a central processing unit (CPU) and a memory, such as a random-access memory (RAM) or a read-only memory (ROM). The memory stores program codes or commands that are configured to have the CPU execute processes. The memory, which is a computer readable medium, may be any available medium that is accessible by a versatile or dedicated computer.

Technical concepts that can be understood from the above embodiment and the modified examples will now be described.

(a) A display device in which the optical material is a transparent material. This configuration improves visual recognition of the image shown on the transparent member such as a light-transmissive glass.

(b) A display device that shows an image by projecting the image from a projector onto a light control member having a variable light transmittance and arranged on an optical material, the display device including circuitry configured to receive a detection signal from a detector configured to detect a brightness of ambient light around the light control member and control at least one of the light transmittance of the light control member and operation of the projector based on the received detection signal to adjust a display state of the image projected onto the light control member in accordance with the brightness of the ambient light.

### REFERENCE SIGNS LIST

1) display system, 2) display screen, 3) projector, 4) display device, 5) optical material, 6) light control member, 7) detector, 11) input unit, 12) controller, 13) memory, D) image data, E) ambient light, L1) image light, S) detection signal, V) control voltage.

1. A display device that shows an image by projecting the image from a projector onto a light control member having a variable light transmittance and arranged on an optical material, the display device comprising:
an input unit that receives a detection signal from a detector configured to detect a brightness of ambient light around the light control member; and
a controller that controls at least one of the light transmittance of the light control member and operation of the projector based on the detection signal received by the input unit to adjust a display state of the image projected onto the light control member in accordance with the brightness of the ambient light.

2. The display device according to claim 1, wherein
the projector intermittently shows the image on the light control member, and
the controller readjusts the display state based on the detection signal obtained at a time during which the image is not shown and repeats the readjustment at a specified time.

3. The display device according to claim 2, further comprising
a memory that stores in advance a control map and a conversion map,
the control map indicating a relationship of the brightness of the ambient light, a first instruction value for controlling the light transmittance of the light control member, and a second instruction value for controlling operation of the projector, and
the conversion map indicating a relationship of a detection value of the detection signal, a present value that has been set as the first instruction value when the detection occurred, and a conversion value of the detection signal,
wherein when the controller controls the light control member with the first instruction value,
the controller uses the conversion map to obtain the conversion value from the detection value and the present value,
the controller uses the obtained conversion value as the brightness of the ambient light to obtain from the control map a new one of the first instruction value and a new one of the second instruction value corresponding to the brightness of the ambient light, and
the controller performs the readjustment of the display state with the obtained new one of the first instruction value and the obtained new one of the second instruction value.

4. The display device according to claim 1, wherein
the controller controls the light control member such that the light transmittance of the light control member increases as the brightness of the ambient light decreases, and
the controller controls the light control member such that the light transmittance of the light control member decreases as the brightness of the ambient light increases.

5. The display device according to claim 1, wherein
the controller controls the projector such that an image brightness of the image projected from the projector decreases as the brightness of the ambient light decreases, and
the controller controls the projector such that the image brightness of the image projected from the projector increases as the brightness of the ambient light increases.

6. The display device according to claim 1, wherein
the controller processes image data of the image projected onto the light control member to control the operation of the projector.

7. The display device according to claim 1, wherein
the light control member is arranged on a glass of a vehicle.

8. A display system that shows an image on a light control member and includes the light control member that has a variable light transmittance and is arranged on an optical material and a projector that projects the image onto the light control member, the display system comprising:
a detector configured to detect a brightness of ambient light around the light control member; and
a display device that receives a detection signal from the detector and controls at least one of the light transmittance of the light control member and operation of the projector based on the received detection signal to adjust a display state of the image projected onto the light control member in accordance with the brightness of the ambient light.
